(19) United States
(12) Patent Application Publication
(10) Pub. No.: US 2024/0378088 A1
(43) Pub. Date: Nov. 14, 2024

(54) APPROACHES TO OPTIMIZING COMPUTE RESOURCE ALLOCATION FOR HEAVY WORKLOADS IN ELASTIC ENVIRONMENTS AND CLOUD DATA PLATFORM FOR IMPLEMENTING THE SAME

(71) Applicant: Cloudera, Inc., Santa Clara, CA (US)

(72) Inventors: Sunil Govindan, Santa Clara, CA (US); Zhankun Tang, Santa Clara, CA (US); Siddharth Seth, Santa Clara, CA (US); Tarun Parimi, Santa Clara, CA (US); Vinod K. Vavilapalli, Santa Clara, CA (US); Tanu Ajmera, Santa Clara, CA (US)

(21) Appl. No.: 18/450,221

(22) Filed: Aug. 15, 2023

Related U.S. Application Data
(60) Provisional application No. 63/502,052, filed on May 12, 2023.

(51) Int. Cl. G06F 9/50

(52) U.S. Cl. CPC G06F 9/5038; G06F 9/5022; G06F 9/5072; G06F 2209/5013; G06F 2209/503; G06F 2209/505

(57) ABSTRACT

Introduced here is a resource management platform (also called a “resource manager”) that is able to dynamically allocate compute resources to workloads to accommodate resource requirements of a tenant in a more efficient and cost-effective manner, especially in scenarios where compute resource availability is elastic in nature. The resource manager can include a scheduling engine and a recommending engine that together are able to optimize the scaling up and down of compute resources in different scenarios. Normally, the resource manager can communicate with a resource-aware, external entity that may be responsible for implementing appropriate changes on a cloud infrastructure. For example, the external entity may be responsible for adding or removing nodes assigned to a given tenant, as well as obtaining relevant attributes of those compute resources from a provider of the cloud infrastructure.

### CROSS-REFERENCE TO RELATED APPLICATIONS

This application claims priority to U.S. Provisional Application No. 63/502,052, titled “Approaches to Optimizing Compute Resource Allocation for Heavy Workloads in Elastic Environments and Cloud Data Platform for Implementing the Same” and filed on May 12, 2023, which is incorporated herein by reference in its entirety.

### TECHNICAL FIELD

Various embodiments concern computer programs and associated computer-implemented techniques for allocating compute resources in elastic environments.

### BACKGROUND

In modern computing, the term “compute resources” is commonly used to refer to infrastructure elements, whether hardware or software, that enable completion of workloads by a computer program through receiving, analyzing, and storing data. The types of workloads that can be completed depend on the amount of compute resources that are available to the computer program, and therefore it has traditionally been important to understand how much compute resources could be needed to complete its largest workloads. Said another way, enterprises have historically needed to understand the largest amount of compute resources that might be needed.

There are several problems with this approach. First, large workloads tend not to be regularly completed, and therefore enterprises rarely need the full allotment of compute resources that are initially requested. Because monetary cost corresponds to the amount of compute resources that are initially requested by enterprises, these enterprises generally overpay for compute resources—sometimes by tens or hundreds of thousands of dollars. Second, the underlying computing architecture that is responsible for provisioning compute resources must be able to accommodate the initial requests by all of its users (also called “tenants”). Assume, for example, that multiple enterprises request compute resources from a public cloud infrastructure. The public cloud infrastructure must be designed and constructed to meet those requests, and as workloads continue to increase in size, be redesigned and reconstructed to add more compute resources. Again, this increases monetary costs but perhaps more importantly, compute resources available to the public cloud infrastructure tend to be underutilized for the reasons set forth above. The public cloud infrastructure must still maintain these vast amounts of compute resources, however, which increases resource costs unnecessarily.

### BRIEF DESCRIPTION OF THE DRAWINGS

FIG. 1 illustrates a network environment that includes a resource manager that is executed by a computing device.

FIG. 2 illustrates a network environment that includes a resource manager for managing the allocation of compute resources by a cloud infrastructure to workloads corresponding to tasks requested by tenants.

FIG. 3 includes an example manifestation of the resource manager that is shown in FIG. 2.

FIG. 4 includes a detailed flowchart that depicts the functionality of the recommending engine of the resource manager.

FIG. 5 is a block diagram illustrating an example of a processing system in which at least some of the operations described herein can be implemented.

Various features of the technology described herein will become more apparent to those skilled in the art from a study of the Detailed Description in conjunction with the drawings. While certain embodiments are depicted in the drawings for the purpose of illustration, those skilled in the art will recognize that alternative embodiments may be employed without departing from the principles of the technology. The technology is amenable to various modifications.

### DETAILED DESCRIPTION

Resource management across public cloud infrastructure requires complex policies for optimum utilization of compute resources. Effective resource management is challenging due to the scale of many public cloud infrastructures, as well as the unpredictable nature of interactions with large populations of tenants. In fact, these large tenant populations can make it difficult, if not impossible, to predict the type, intensity, and frequency of workloads to be handled by these public cloud infrastructures.

A resource management system (or simply “system”) provides for the ability to run distributed workloads—including large workloads like those related to big data—across a fleet of compute resources accessible to a public cloud infrastructure. At a high level, a system can attend to planning, scheduling, and allocating these compute resources, among other things, to serially or simultaneously complete aspects of a workload. Some core functionalities offered by these systems include:
Multi-tenancy constructs that allow for the sharing of the same fleet of compute resources across different tenants (also called “end users” or simply “users”) or different teams of tenants;
Guarantees of compute resources, with the ability for tenants to use more capacity than is naturally or normally allocated to them when unused compute resources are available;
Reactivity to dynamic resource demands, which are a common characteristics of large workloads associated with resource-heavy tasks like those related to big data; and
Offering of service-level agreements (“SLAs”) for workloads to execute, typically via the multi-tenancy constructs and/or resource guarantee constructs offered by these systems.

Normally, these systems manage a fairly static fleet of compute resources in deployments where elastic compute resources are not available. With the growth of public cloud infrastructure and improved availability of elastic compute resources, several opportunities—and challenges—are presented to these systems. For example, the need for these systems to assist with large workloads having the aforementioned characteristics remains, and these systems need to adjust to the opportunities and challenges resulting from deployments involving public cloud infrastructure.

Public cloud infrastructure can have elastic compute resources available in short order, generally no more than several minutes. The additional compute resources come at a cost, however.

When running on public cloud infrastructure (or another environment where compute resources are elastic), the conventional approach of having a static fleet of compute resources available to a system tends to be inefficient in terms of financial cost. Simply put, the system may rarely require a meaningful percentage of the static fleet of compute resources for large workloads, but those large workloads tend to correspond to important tasks and therefore, the static fleet of compute resources must be sufficiently large to accommodate those large workloads. Not only do these rarely used compute resources correspond to unnecessary financial cost, but managing these rarely used compute resources can “tax” the system and underlying public cloud infrastructure. Several additional considerations can be leveraged in an effort to reduce financial cost, namely:
The availability of elastic compute resources;
The availability of compute resources in different increments (e.g., the availability of nodes of different sizes);
The varying financial costs in near real time of elastic compute resources; and
The avoidance of under-utilization of available compute resources.

Though these considerations should be leveraged while continuing to provide the core competencies of a system, namely, (i) multi-tenancy with compute resource guarantees for tenants, (ii) SLA requirements for distributed workloads; (iii) reactivity to dynamic compute resource demands made by workloads; and (iv) the option to “steal” or “borrow” compute resources across tenants.

Introduced here is a resource management platform (also called a “compute resource manager” or simply “resource manager”) that is able to dynamically allocate compute resources to workloads in a more efficient and cost-effective manner. At a high level, the resource manager includes a resource scheduling module (also called a “resource scheduling engine,” “job scheduler,” or “scheduler”) and a scale recommending module (also called a “scale recommending engine,” “scale recommender,” or “recommender”) that together are able to optimize the scaling up and down of compute resources in different scenarios. Normally, a resource-aware, external entity is able to interact with the resource manager as further discussed below, and therefore the external entity may be responsible for implementing appropriate changes on a cloud infrastructure. For example, the external entity may be responsible for adding or removing nodes assigned to a given tenant, as well as obtaining relevant attributes of those compute resources from a provider of the cloud infrastructure.

Resource-heavy workloads, like those related to big data, require compute resources on nodes. Generally, the scheduling engine uses algorithms to distribute workloads across the compute resources that are available to the scheduling engine. More specifically, the scheduling engine can set up scheduled units of work—like entire workloads or portions of workloads, for example—to be executed at defined times or regular intervals. As further discussed below, the scheduling engine can also attempt to “pack” the compute resources into as few nodes as possible, while respecting workload demand and SLA needs for each use case. For the purpose of illustration, the unit of scaling used throughout the present disclosure is an individual node. However, those skilled in the art will recognize that any unit of scaling (e.g., 2 nodes, 3 nodes, or 5 nodes) could be used. The intent of this optimization is to decrease (e.g., minimize) the number of nodes that are used to satisfy the demands of large workloads. Moreover, such an approach can increase (e.g., maximize) the number of nodes that are in a “reapable” state at any given point in time. Nodes in the “reapable state” are those nodes that can be dynamically allocated to a different cluster due to underutilization. Together, these outcomes serve to reduce the overall number of nodes required across a set of tenants, and therefore reduce processing costs and financial costs of the underlying cloud infrastructure.

In operation, the recommending engine may be responsible for generating recommendations on how many new nodes are required to fulfill demand of a workload in real time. Similarly, the recommending engine may be able to generate recommendations on how many nodes are no longer needed by the resource manager. The recommending engine can factor in aspects like quota allocation to tenants, loss-of-work prevention while recommending nodes for deletion, and various parameters regarding nodes such as sizes, costs, and the like—all with the goal of optimization in terms of processing costs or financial costs—while making the overall recommendation. Meanwhile, the scheduling engine may be responsible for effecting or implementing recommendations output by the recommending engine. In essence, the scheduling engine could serve as the “brains” for executing recommendations output by the recommending engine. In sum, the recommending engine and the scheduling engine may support the following features:
Demand-based capacity scaling that is responsive to information received from the scheduling engine, in real time, regarding the current demand on the underlying cloud infrastructure; and
Honoring queues' resource quota allocations while making decisions on current scaling requirements.

In addition to the scheduling engine and recommending engine, the resource manager can include a workload allocating module (also called a “workload allocating engine”). The allocating engine may be responsible for causing resources to be allocated in accordance with the recommendations output by the recommending engine and scheduled by the scheduling engine, as well as optimize the “packing” of workloads by the resource manager. For example, the allocating module may optimize “packing” of workloads by programmatically establishing the fewest number of nodes that are needed to complete the workloads. By “packing” workloads into the fewest number of nodes that are needed—preferably in an ongoing manner—the allocating module can make a larger number of the nodes releasable for reallocation.

### Terminoloqy

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

The term “based on” is to be construed in an inclusive sense rather than an exclusive sense. That is, in the sense of “including but not limited to.” Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

The term “big data” is commonly used to refer to data that is huge in volume and growing, generally exponentially. Rather than establish a static threshold for size, the term “big data” tends to be used to describe datasets whose size or type is beyond the ability of traditional databases (e.g., relational databases) to readily capture, manage, and process.

The term “compute node” or “node” is commonly used to refer to a single computational unit that can perform work. Generally, a node is representative of a distinct unit of compute resources that can be assigned to a tenant or to which a workload—or a portion of a workload—can be assigned. Nodes provide the storage, networking, memory, and processing resources that can be used to handle workloads. Note that while the term “node” is commonly used to refer to hardware, the term “node” could also be used to refer to software (e.g., in the form of virtual machines).

The term “engine” may be used to refer to a computer program, or a part of a computer program, that serves a core functionality for a larger piece of software. Multiple engines can be designed to work in concert with one another, such that the larger piece of software is able to perform complex tasks.

### Overview of Resource Manaqer

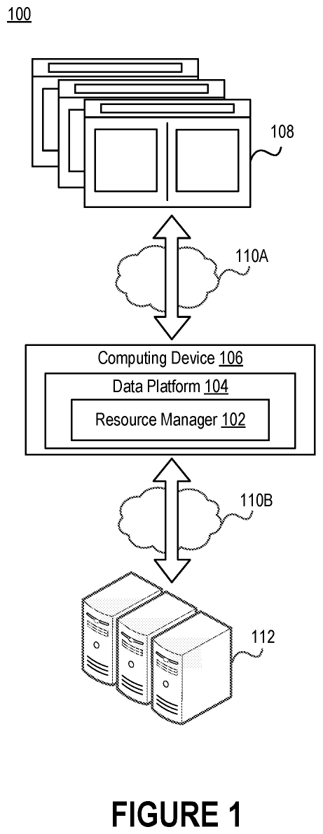

FIG. 1 illustrates a network environment 100 that includes a resource manager 102 that is executed by a computing device 106. As mentioned above, the resource manager 102 may also be called a “resource management platform.” The resource manager 102 may be executed as part of a data platform 104 through which tasks can be requested to be performed on a server system 112 and through which outputs produced as a result of completing those tasks can be viewed.

Generally, the computing device 106 is a computer server that is part of a server system 112 accessible via the Internet. However, the computing device 106 could be a personal computing device, such as a mobile phone, tablet computer, or desktop computer, that is accessible to the server system 112 as further discussed below. Users may be able to interface with the data platform 104 via interfaces 108 that are accessible via respective computing devices. For example, a user may be able to access the interface 108 through a web browser that is executing on a laptop computer or desktop computer. Similarly, users may be able to access the interfaces 108 through computer programs such as mobile applications and desktop applications.

As shown in FIG. 1, the data platform 104 may reside in a network environment 100. Thus, the computing device 106 on which the data platform 104 resides may be connected to one or more networks 110A-B. These networks 110A-B may be personal area networks (“PANs”), local area networks (“LANs”), wide area networks (“WANs”), metropolitan area networks (“MANs”), cellular networks, or the Internet.

The interfaces 108 may be accessible via a web browser, desktop application, mobile application, or another form of computer program. For example, in embodiments where the data platform 104 resides on a computer server (e.g., that is part of a server system 112), a user may interact with the data platform 104 through interfaces displayed on a desktop computer by a web browser. As another example, in embodiments where the data platform 104 resides—at least partially—on a personal computing device (e.g., a mobile phone, tablet computer, or laptop computer), a user may interact with the data platform 104 through interfaces displayed by a mobile application or desktop application. However, these computer programs may be representative of thin clients if most of the processing is performed external to the personal computing device (e.g., on a server system 112).

Generally, the data platform 104 is either executed by a cloud computing infrastructure operated by, for example, Amazon Web Services, Google Cloud Platform, Microsoft Azure, or another provider, or provided as software that can run on dedicated hardware nodes in a data center. For example, the data platform 104 may reside on a server system 112 that comprises one or more computer servers. These computer servers can include different types of data (e.g., associated with different users), algorithms for processing the data, and other assets. Those skilled in the art will recognize that this information could also be distributed among the server system 112 and one or more personal computing devices. For example, data may initially be stored on a personal computing device and then uploaded to the server system 112 (e.g., for storage or analysis as part of a workload).

As further discussed below, the resource manager 102 may be responsible for dynamically scaling the compute resources made available by the server system 112 to workloads. Users may request, via the interfaces 108, the completion of these workloads, or these workloads may complete on their own. Generally, these workloads involve large amounts of data maintained on the server system 112. However, the data platform 104 may allow use of any data under management within the “data cloud” of the corresponding user. The data cloud (also called the “data lake”) could include data stored on public cloud infrastructure, private cloud infrastructure, or both. Accordingly, the data cloud could include data that is stored on, or accessible to, the server system 112 as well as any number of personal computing devices.

Note that the tasks corresponding to workloads are generally managed (e.g., requested) through workspaces that are independently accessible to and manipulable by different users. For example, the data platform 104 may support a first workspace that is accessible to a first set of users corresponding to a first tenant and a second workspace that is accessible to a second set of users associated with a second tenant, and any work within the first workspace may be entirely independent of work in the second workspace. Generally, the first and second sets of users are entirely distinct. For example, these users may be part of different companies. However, the first and second sets of users could overlap in some embodiments. For example, a company could assign a first set of data scientists to the first workspace and a second set of data scientists to the second workspace, and at least one data scientist could be included in the first set and second set. Similarly, a single user may instantiate or access multiple workspaces. These workspaces may be associated with different projects, for example.

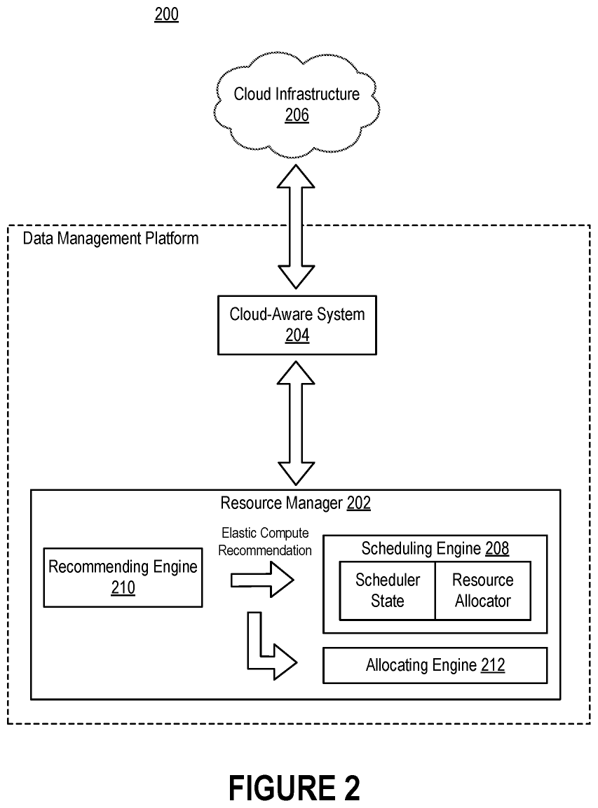

FIG. 2 illustrates a network environment 200 that includes a resource manager 202 for managing the allocation of compute resources by a cloud infrastructure 206 to workloads corresponding to tasks requested by tenants. As shown in FIG. 2, the resource manager can include a scheduling engine 208 and recommending engine 210.

The resource manager 202 can ensure more predictable behavior by establishing the impact of different workloads on compute resources available from the cloud infrastructure 206. The cloud infrastructure 206 may be the computational system (also called a “computational architecture” or “computational infrastructure”) that provides elastic compute resources. The cloud infrastructure 206 could be operated by Amazon Web Services®, Google Cloud Platform™, or Microsoft Azure®, for example. Through better management of these compute resources, the resource manager 202 can (i) guarantee completion of critical workloads—even large ones—in a reasonable timeframe; (ii) support reasonable scheduling between different users based on configured resource-sharing policies (e.g., fair allocation of resources on a per-user basis); and (iii) prevent users from depriving other users access to the compute resources.

As mentioned above, the resource manager 202 may be responsible for ensuring that compute resources are allocated to tenants as necessary, so as to ensure that workloads are readily addressed without requiring that large reserves of compute resources be reserved for each user of the cloud infrastructure 206. To accomplish this, the resource manager 202 may be continually aware of compute resources that can be provided from the cloud infrastructure 206, along with attributes associated with these compute resources such as node type, availability, financial cost, etc. Specifically, the resource manager 202 may interface with a resource-aware, external entity that can provide such information. This external entity may be called the “cloud-aware system” or “resource-aware system.” Note that the cloud-aware system 204 is generally not part of the cloud infrastructure 206, but instead executes or runs on top of the cloud infrastructure 206 for better network communication (e.g., with computing devices that are external to the cloud infrastructure 206).

The cloud-aware system 204 can allocate and manage physical nodes in the cloud infrastructure 206, while the resource manager 202 can construct and manage a logical resource pool based on these physical nodes and the dynamic workloads assigned to these physical nodes for completion. Specifically, the cloud-aware system 204 may be the part of a data management platform that is responsible for operations like figuring out what types of nodes (and other attributes) are offered by the cloud infrastructure 206, provisioning resources to the cloud infrastructure 206, and deprovisioning resources from the cloud infrastructure 206—generally based on, or in accordance with, instructions provided by the resource manager 202. Accordingly, the cloud-aware system 204 may need the resource manager 202 to provide instructions regarding how to scale these physical nodes and better manage compute resources, though the cloud-aware system 204 may be responsible for actually effecting instructions from the resource manager 202.

Generally, the cloud-aware system 204 is supported or maintained by the data management platform of which the resource manager 202 is a part, as shown in FIG. 2. However, in some embodiments, the cloud-aware system 204 is external to the data management platform, though it may operate “alongside” the data management platform (and therefore, the resource manager 202). Regardless of its location, the cloud-aware system 204 may be responsible for creating, based on outputs produced by the resource manager 202, instructions that are implementable by the cloud infrastructure 206.

The resource manager 202 may also be supported or maintained by the cloud infrastructure 206, in which case communications between the resource manager 202 and cloud-aware system 204 may not traverse any networks. Alternatively, the resource manager 202 may be external to the cloud infrastructure 206, in which case the cloud-aware system 204 may be accessible to the resource manager 202 via an application programming interface (“API”) or another type of data interface. Moreover, the resource manager 202 may also be continually aware of scalability characteristics of each cluster of nodes maintained by the cloud infrastructure 206 for a tenant. Such knowledge allows the resource manager 202 to dynamically scale cluster size by deleting nodes that do not store permanent data, as further discussed below.

In some embodiments, the resource manager 202 is able to interface with the cloud-aware system 204 to provision or reclaim nodes. Said another way, the resource manager 202 may be able to add nodes to, or remove nodes from, clusters by communicating such requests directly to the cloud infrastructure 206 or indirectly to the cloud infrastructure (e.g., via the cloud-aware system 204). Accordingly, the resource manager 202 may cause nodes to be provisioned or reclaimed via communication of appropriate requests to the cloud-aware system 204 or cloud infrastructure 206.

The recommending engine 210 may be responsible for generating an appropriate scaling recommendation by rationalizing demand against compute resource availability, for example, as indicated by the cloud-aware system 204. Scaling recommendations can be based on a number of factors, including the current state (e.g., whether the compute resources assigned to a given tenant are currently being utilized), the degree to which compute resource quotas established for other tenants are currently being utilized, the amount of compute resources that are currently available to be utilized, the hardware that is currently available (and the characteristics of the hardware), and the like. Note that, in some embodiments, the resource manager 202 or the cloud-aware system 204 may be able to discard demand. This could be done for several reasons (e.g., if such demand would cause wastage, if new nodes would need to be added to accommodate such demand, if users cannot claim such demand). The elastic compute recommendation that is produced, as output, by the recommending engine 210 can be provided, as input, to the scheduling engine 208 as shown in FIG. 2. This interaction is typically to facilitate linking specialized requests and the corresponding nodes being provisioned.

In FIG. 2, the scheduling engine 208 includes two components, namely, the scheduler state and resource allocator. The scheduler state may be representative of the part of the scheduling engine 208 that includes state information about aspects such as current allocation of compute resources, current usage of compute resources, current availability of compute resources, pending demand for compute resources, tenant-aware allocations of compute resources, configured tenant-specific quotas, etc. Meanwhile, the resource allocator may be representative of the part of the scheduling engine 208 that is responsible for allocating compute resources, including optimizations for using compute resources available from the cloud infrastructure 206. Generally, the resource allocator employs a strategy that is tailored to maximize the number of “reapable” nodes, so as to provide maximum flexibility in provisioning nodes as necessary. Moreover, the resource allocator may optimize the placement of work based on the “loss-of-work” impact on workloads.

With respect to the problems described above, this approach to developing a resource manager 202 introduces two important changes. First, the recommending engine 210 is introduced in the resource manager 202, and the scheduling engine 208 is made accessible to the recommending engine 210, allowing for information about the state of the scheduling engine 208 to be pulled in real time. Second, the resource allocation mechanisms that are used by the scheduling engine can be altered to allow for more optimized usage of compute resources, with a target of maximizing the number of nodes that are in the “reapable” state.

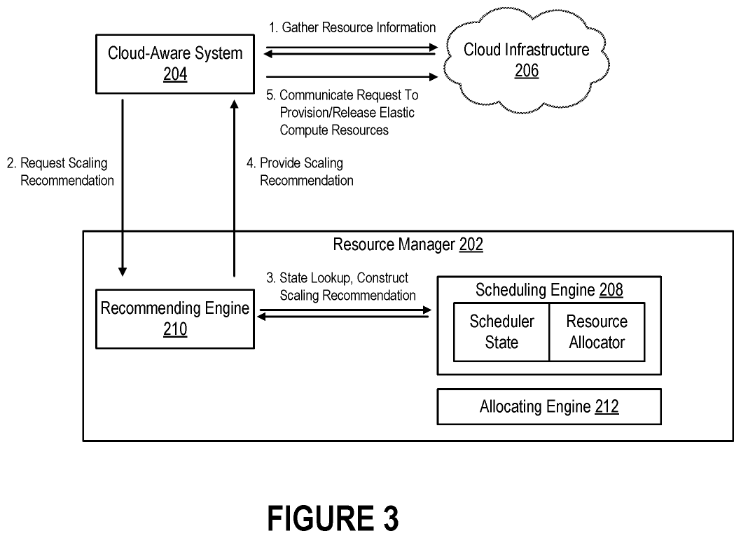

FIG. 3 includes an example manifestation of the resource manager 202 that is shown in FIG. 2. Specifically, FIG. 3 depicts a mechanism in which the scaling requests are initiated by an external entity, namely, the cloud-aware system 204. As mentioned above, the cloud-aware system 204 is typically aware of the functionalities of different nodes on the underlying cloud infrastructure 206, as well as the data stored on those different nodes. As such, the cloud-aware system 204 may be able to, upon receiving appropriate instructions from the resource manager 202, cause elimination of nodes that could, but presently do not, store permanent data as candidates for scaling operations.

An overall flow of the example manifestation is set forth below for the purpose of illustration. The cloud-aware system 204 can run iteratively on a schedule (e.g., every one minute, two minutes, or five minutes), such that demand of a tenant is compared against the compute resources of the corresponding cluster on a periodic basis. On each iteration, the cloud-aware system 204 can query the cloud infrastructure 206 (e.g., via a call to an appropriate API) to establish which compute resources are presently available. For example, the cloud-aware system 204 may query the cloud infrastructure 206 to determine various characteristics of available compute resources. In response, the cloud infrastructure may describe the attributes or capabilities of the available compute resources. Examples of such attributes includes the types of nodes that are presently available (e.g., type of processing unit, for example, whether central processing unit (“CPU”) or graphic processing unit (“GPU”), the abilities of those processing units, memory sizes, etc.). the current financial cost of the nodes, the availability or allocation probability or the nodes, the probability of losing a node with certain attributes, etc.

The cloud-aware system 204 can then request a scaling recommendation from the recommending engine 210 of the resource manager 202. In some embodiments, the cloud-aware system 204 may also request desired attributes of available compute resources, and any desired attributes specified by the recommending engine 210 can be compared against the actual attributes specified by the cloud infrastructure 206. Accordingly, the scaling recommendation may account for the characteristics of the compute resources that are known to be available.

Then, the recommending engine 210 can query the scheduling engine 208 (and more specifically, its scheduler state) for real-time scheduling information regarding pending demand. The recommending engine 210 can proceed to build, construct, or otherwise establish a recommendation based on (i) the actual attributes of available compute resources; (ii) the desired attributes for compute resources; or (iii) current demand for compute resources. To construct the final recommendation, the recommending engine 210 can rationalize the real-time scheduling information against availability and preferred attributes of compute resources. Additional factors that could be considered by the recommending engine 210 in formulating the final recommendation include:
The existence of pending demand;
Whether tenant-level pending demand is valid (e.g., within the quota allocated to that tenant);
All valid pending demand;
The optimization of pending demand across all tenants such that compute resources can be requested in order of increasing financial cost while factoring in loss, such that the recommending engine 210 may recommend a combination of nodes with different failure probabilities to limit the impact of overall loss of work; or
An analysis of pending demand and current utilization to determine if any unused nodes are safe for deletion, while ensuring that deletion of such unused nodes would not cause loss of work for existing workloads.

Accordingly, in formulating the recommendation, the recommending engine 210 may consider characteristics of the compute resources that are presently allocatable and/or characteristics of the compute resources that are already allocated. For example, the recommending engine 210 may prioritize release of those compute resources that are not presently allocatable, or the recommending engine 210 may prioritize release of those compute resources that are “over allocated” to a given tenant.

The recommending engine 210 can then inform the cloud-aware system 204 of its findings. Specifically, the recommending engine 210 can provide, as input, a recommendation to the cloud-aware system 204 that specifies which nodes should be added or removed from the cluster available to a given tenant in order to accommodate a workload. For example, the recommending engine 210 may send, to the cloud-aware system 204, a communication that includes information about new nodes that are to be added to a cluster associated with a tenant, and therefore made available to complete a workload associated with the tenant. As another example, the recommending engine 210 may send, to the cloud-aware system 204, a communication that includes information about existing nodes that have been deemed safe to remove from a cluster associated with a tenant, and therefore made available for assignment to other tenants of the cloud infrastructure 206. In some embodiments, the recommending engine 210 additionally informs the scheduling engine 208 about specify resources or resource requirements of a workload (e.g., a graphics processing unit or “GPU”) so that the scheduling engine 208 can then reserve these resources for the workload or corresponding tenant.

The cloud-aware system 204 may be responsible for acting on recommendations made by the recommending engine 210. Accordingly, the cloud-aware system 204 may take action on recommendations, for example, by “releasing” compute resources that are no longer required and/or “claiming” compute resources that are required to execute a current workload or upcoming workload. Generally, this is done on a per-node basis, such that the cloud-aware system 204 releases or claims individuals nodes as necessary, in accordance with recommendations from the recommending engine 210.

In some embodiments, the recommending engine 210—rather than the scheduling engine 208—is responsible for submitting requests to release or claim compute resources. The recommending engine 208 may submit these requests to the cloud-aware system 204 based on either real-time information acquired from the scheduling engine 208 or an aggregated view of the pending demand on the cloud-aware system 204 or cloud infrastructure 206. Such an approach causes the direction of communication to “flip,” though the same functionality in the overall system is achieved.

The recommending engine 210 may also be responsible for generating recommendations on whether to release or claim compute resources. For example, the recommending engine 210 may generate a recommendation that specifies how many new nodes are required to fulfill demand of a workload in real time. As another example, the recommending engine 210 may generate a recommendation that specifies how many nodes are no longer needed, and therefore can be released for use by other tenants of the cloud infrastructure 206.

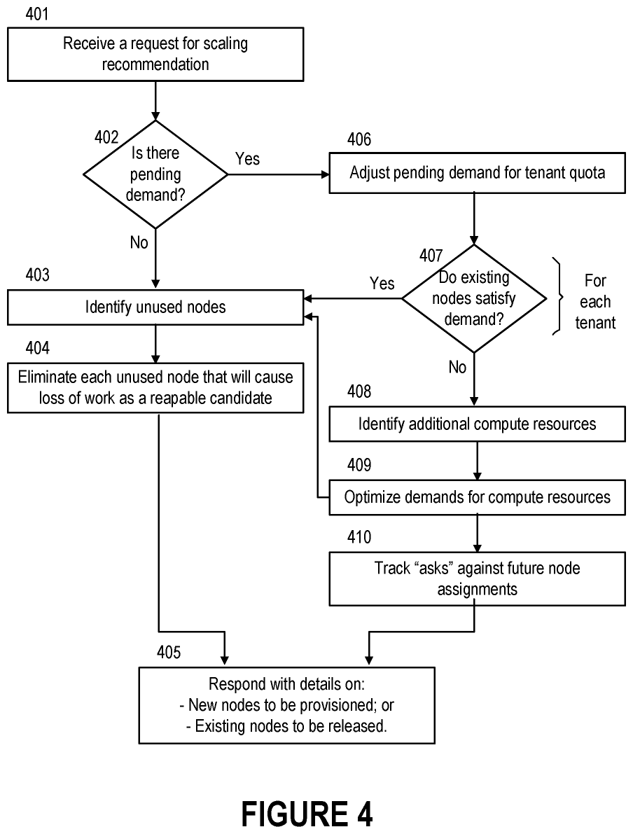

FIG. 4 includes a detailed flowchart that depicts the functionality of the recommending engine 210. Initially, the recommending engine 210 can receive a request for a scaling recommendation from the cloud-aware system 204 (step 401). Said another way, the recommending engine 210 can receive input, from the cloud-aware system 204, that is indicative of a request for a recommendation of an appropriate amount of compute resources to allocate to a single tenant, a set of tenants (e.g., associated with a single company), or all tenants of the cloud infrastructure 206. Upon receiving the request, the recommending engine 210 can determine whether the scheduling engine 208 has pending demand (step 402). Specifically, the recommending engine 210 may query the scheduling engine 208 to determine what, if any, workloads are pending completion.

In the event that there is no pending demand, the recommending engine 210 can identify unused nodes (step 403) and then recommend eliminating nodes until existing work is finished (step 404). Said another way, the recommending engine 210 can eliminate nodes that would cause loss of work as downscale candidates (also called “reapable candidates”). Specifically, for each unused node, the recommending engine 210 can recommend that the unused node be released. To accomplish this, the recommending engine 210 may specify, to the cloud-aware system 204, the nodes for which utilization is beneath a threshold or does not match a criterion, and therefore are safe to release back to the cloud infrastructure 206 (step 405). For example, the recommending engine 210 may identify the nodes that are entirely unused and/or that do not store necessary information.

In the event that there is pending demand, the recommending engine 210 can adjust the pending demand for quota of the corresponding tenant (step 406). For each tenant, the recommending engine 210 can determine whether the existing nodes satisfy quota-adjusted demand (step 407). If the recommending engine 210 determines that the existing nodes satisfy the quota-adjusted demand, the recommending engine can identify the unused nodes (step 403) and then further prune this list to exclude nodes that will cause loss of work (step 404) as discussed above.

In response to a determination that the existing nodes do not satisfy quota-adjusted demand, the recommending engine 210 can identify additional compute resources that are needed to satisfy the quota-adjusted demand (step 408). For example, the recommending engine 210 may identify additional hardware or software that is needed to accommodate the demand. Thereafter, the recommending engine 210 can optimize demands for those additional compute resources (step 409). For example, the recommending engine 210 may optimize the demands based on node size, node availability, node resources, financial cost, or some combination thereof that will satisfy workload, tenant, and/or SLA requirements. As shown in FIG. 4, the recommending engine 210 may revert to steps 403-404 in the event that such optimization reveals that a needed node is presently assigned to another tenant but not being used. Accordingly, the recommending engine 210 may recommend that a node be “stolen” or “borrowed” from another tenant if the node is necessary but not presently being used by the other tenant.

In some embodiments, the recommending engine 210 is configured to annotate, note, or otherwise document these “asks” for nodes in order to track against future node assignments (step 410). For example, the recommending engine 210 may document each “ask” for a node by populating information (e.g., node type, node size, request date) in a data structure that is representative of a digital record. Thus, the recommending engine 210 may document transfers of nodes between tenants, as well as simple provisions of nodes by the cloud infrastructure 206, by populating information regarding the transfers and provisions in a data structure that is representative of a digital record. The digital record may be associated with a single tenant, a set of tenants (e.g., those associated with a single company), or all tenants of the cloud infrastructure 206. This approach to documenting transfers and provisions may be helpful if the resource manager 202 is interested in tracking nodes. For example, documenting these “asks” may allow the resource manager 202 to establish when a given node (e.g., specialized hardware such as a GPU) is generally requested, the tasks for which the given node is generally requested, the tenants for which the given node is generally requested, etc.

The recommending engine 210 can then notify the cloud-aware system 204 with details on the new node(s) that are needed. For example, the recommending engine 210 may specify, to the cloud-aware system 204, the node(s) to be claimed to accommodate the quota-adjusted demand (step 405). In some embodiments the recommending engine 210 is configured to identify characteristics of the node(s) to be claimed, while in other embodiments the recommending engine 210 is configured to identify the node(s) themselves (e.g., where information regarding the nodes is obtained by the cloud-aware system 204 and provided to the resource manager 202).

To support the goals of the resource manager 202, the allocating engine 212 may also be enhanced. For example, the allocating engine 212 may be designed to optimize “packing” of workloads by programmatically establishing the fewest number of nodes that are needed to complete the workloads. Thus, the allocating engine 212 may attempt to “pack” workloads into as few nodes as possible, while respecting workload demand and SLA needs. This may be done in an effort to maximize the number of “reapable” nodes that are maintained by the cloud infrastructure 202, while at the same time satisfying existing capacity demand by utilizing nodes that are already doing work.

When deciding how to allocate compute resources (e.g., via the assignment of nodes), an attempt may be made to place workloads that, in the event of failure, would experience a large amount of “loss of work” onto nodes that are less likely to be lost. Said another way, the resource manager 202 may attempt to strategically place higher value workloads onto nodes that are less susceptible to failure. To achieve this, the resource manager 202 may utilize constructs where a workload can indicate, either expressly or inherently, the level of severity of loss of work for different parts of the workload. An example of a part of a workload that could result in large loss of work is the part of the workload that is responsible for coordinating the actual work between executable files (also called “executors”). Such an approach also allows for associating relevant attributes on nodes, which can be matched against the aforementioned constructs.

### Processing System

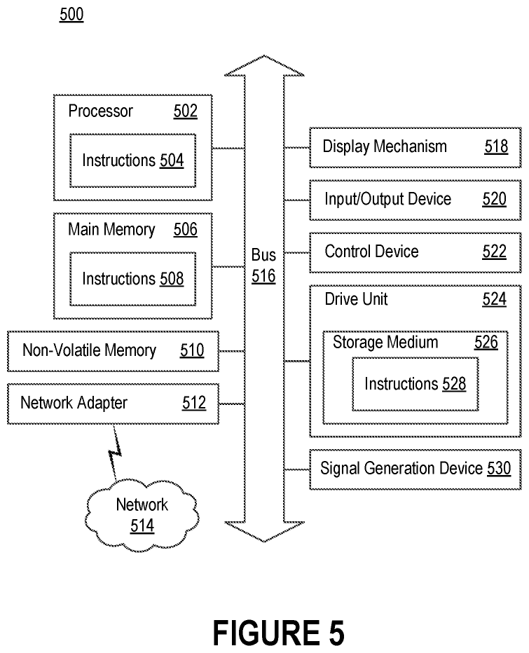

FIG. 5 is a block diagram illustrating an example of a processing system 500 in which at least some of the operations described herein can be implemented. For example, components of the processing system 500 may be hosted on a computing device that includes a data platform, resource manager, or cloud-aware system, or components of the processing system 500 may be hosted on a computing device with which a user interacts with a data platform (e.g., via interfaces).

The processing system 500 may include a processor 502, main memory 506, non-volatile memory 510, network adapter 512, display mechanism 518, input/output device 520, control device 522, drive unit 524 including a storage medium 526, or signal generation device 530 that are communicatively connected to a bus 516. Different combinations of these components may be present depending on the nature of the computing device in which the processing system 500 resides. The bus 516 is illustrated as an abstraction that represents one or more physical buses or point-to-point connections that are connected by appropriate bridges, adapters, or controllers. Thus, the bus 516 can include a system bus, a Peripheral Component Interconnect (“PCI”) bus or PCI-Express bus, a HyperTransport or industry standard architecture (“ISA”) bus, a small computer system interface (“SCSI”) bus, a universal serial bus (“USB”), inter-integrated circuit (“1²C”) bus, or an Institute of Electrical and Electronics Engineers (“IEEE”) standard 1394 bus (also called “Firewire”).

While the main memory 506, non-volatile memory 510, and storage medium 526 are shown to be a single medium, the terms “machine-readable medium” and “storage medium” should be taken to include a single medium or multiple media (e.g., a centralized or distributed database and associated caches and computer servers) that store one or more sets of instructions 528. The terms “machine-readable medium” and “storage medium” shall also be taken to include any medium that is capable of storing, encoding, or carrying instructions for execution by the processing system 500.

In general, the routines executed to implement embodiments of the present disclosure may be implemented as part of an operating system or a specific computer program. A computer program typically comprises instructions (e.g., instructions 504, 508, 528) set at various times in various memory and storage devices in a computing device. When read and executed by the processor 502, the instructions cause the processing system 500 to perform operations in accordance with aspects of the present disclosure.

Further examples of machine- and computer-readable media include recordable-type media, such as volatile memory devices and non-volatile memory devices 510, removable disks, hard disk drives, and optical disks (e.g., Compact Disk Read-Only Memory (“CD-ROMs”) and Digital Versatile Disks (“DVDs”)), and transmission-type media, such as digital and analog communication links.

The network adapter 512 enables the processing system 500 to mediate data in a network 514 with an entity that is external to the processing system 500 through any communication protocol supported by the processing system 500 and the external entity. The network adapter 512 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments can vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method for allocating compute resources of a cloud infrastructure, the method comprising:
receiving input that is indicative of a request for a recommendation of an appropriate amount of compute resources for a cluster associated with a tenant of the cloud infrastructure;
determining that pending demand from the tenant for compute resources is within a quota allocated to the tenant;
identifying at least one node in the cluster that is (i) presently unused and/or (ii) does not store information needed for an existing workload;
causing transmission of a communication that identifies each identified node as a candidate for release from the cluster.

2. The method of claim 1, wherein the communication is transmitted to the cloud infrastructure that, upon receipt, releases each identified node from the cluster.

3. The method of claim 1, further comprising:
querying the cloud infrastructure for information regarding nodes available from the cloud infrastructure; and
receiving, in response to said querying, a response that includes the information regarding the nodes available from the cloud infrastructure.

4. The method of claim 3, wherein the information specifies attributes or capabilities of the nodes.

5. The method of claim 3, wherein said identifying is based on the information, such that the identified nodes are prioritized for release from the cluster.

6. A method for allocating compute resources of a cloud infrastructure, the method comprising:
receiving input that is indicative of a request for a recommendation of an appropriate amount of compute resources for a cluster associated with a tenant;
determining that pending demand from the client for compute resources is within a quota allocated to the tenant;
identifying additional compute resources that are needed to satisfy the pending demand; and
causing transmission of a communication that specifies (i) the additional compute resources or (ii) a new node as a candidate for provision to the cluster.

7. The method of claim 6, further comprising:
querying the cloud infrastructure for information regarding nodes that are available to be provisioned by the cloud infrastructure; and
receiving, in response to said querying, a response that includes the information regarding the nodes that are available to be provisioned by the cloud infrastructure.

8. The method of claim 7, further comprising:
identifying, based on the information, the new node as a candidate for provision to the cluster in response to a determination that the new node is able to provide the additional compute resources.

9. The method of claim 6, wherein the quota is representative of a predetermined amount of compute resources that is initially allocated to the tenant.

10. The method of claim 6, further comprising:
optimizing demand for the additional compute resources based on (i) node size, (ii) node availability, (iii) node resources, or (iv) financial cost.

11. The method of claim 6, further comprising:
determining that the additional compute resources are offered by a node that is presently assigned to another tenant but is presently unused; and
causing transmission of another communication that identifies the node as a candidate for release from another cluster associated with the other tenant.

12. The method of claim 11, wherein the other communication is transmitted to the cloud infrastructure that, upon receipt, releases the node from the other cluster associated with the other tenant and provisions the node to the cluster associated with the tenant.

13. The method of claim 12, further comprising:
documenting a transfer of the node from the other tenant to the tenant by populating information into a data structure that is representative of a digital record.

14. The method of claim 13, wherein the information includes node type, node size, node resources, request date, or a combination thereof.

15. A non-transitory medium with instructions stored thereon that, when executed by a processor of a computing device, cause the computing device to perform operations comprising:
comparing, on a periodic basis, demand for compute resources by a tenant against a quota that is defined for the tenant, for which nodes in a cluster are maintained by a cloud infrastructure; and
addressing changes in the demand in a dynamic manner by—
identifying, to the cloud infrastructure, an existing node as a candidate for release from the cluster in response to a determination that demand exceeds the quota, and
identifying, to the cloud infrastructure, a new node as a candidate for provision to the cluster in response to a determination that demand is within the quota.

16. The non-transitory medium of claim 15, wherein the operations further comprise:
determining, on an ongoing basis, a fewest number of the nodes that are needed to complete a workload; and
causing the workload to be assigned to the fewest number of the nodes, so as to maximize a number of the nodes that are releasable from the cluster.

17. The non-transitory medium of claim 15, wherein the operations further comprise:
analyzing, on an ongoing basis, the demand in combination with current utilization of the compute resources available to the tenant, so as to determine whether any of the nodes in the cluster are suitable for release while also ensuring that release would not cause loss of work for an existing workload.

18. The non-transitory medium of claim 15, wherein the cluster is scaled by requesting release or provision of individual nodes.

19. The non-transitory medium of claim 15, wherein said comparing is performed at least every five minutes.

20. The non-transitory medium of claim 15, wherein the operations further comprise:
querying the cloud infrastructure for information regarding nodes that are available for provisioning; and
receiving, in response to said querying, a response that includes the information regarding the nodes that are available for provisioning.

21. The non-transitory medium of claim 19, wherein the new node is identified based on an analysis of the information.
